(19) United States
(12) Patent Application Publication
(10) Pub. No.: US 2009/0106290 A1
(43) Pub. Date: Apr. 23, 2009

(54) METHOD OF ANALYZING MANUFACTURING PROCESS DATA

(76) Inventor: James P. Rivard, Cornell, MI (US)

Correspondence Address: Edward O. Yonter;Patent and Licensing Department, Nalco Company, 1601 West Diehl Road, Naperville, IL, 60563-1198, US

(21) Appl. No.: 11/873,511

(22) Filed: Oct. 17, 2007

(51) Int. Cl. G06F 17/30

(52) U.S. Cl. 707/102; 707/E17.005

(57) ABSTRACT

Disclosed are methods and apparatus for analyzing data associated with a manufacturing process. The method includes analyzing and comparing datasets representing manufacturing process variables by applying a mathematical function to the combined data and graphically analyzing the resulting output based upon user-selected criteria. In addition, the methods are capable of applying a filtering scheme to correct erroneous data or merge certain types of data points.

### TECHNICAL FIELD

This invention relates generally to methods of analyzing data associated with a manufacturing process. More specifically, the invention relates to methods of analyzing and comparing datasets representing manufacturing process variables. The invention has particular relevance to combining a plurality of datasets representing a plurality of process variables and applying a mathematical function to the combined data and graphically analyzing the resulting output.

### BACKGROUND

Manufacturing processes (e.g., papermaking processes, boiler systems, petrochemical operations) often archive vast amounts of data in many different archiving systems. For example, a papermaking process may produce and archive thousands of variables associated and associated data, such as amount of retained fiber, fiber opacity, sheet ash, jet velocity, moisture content, machine speeds, sheet draws, stock temperature, number of detected holes, etc. A major challenge for handling such vast amounts of data is combining the datasets into a common dataset for analysis. Often, this data holds important clues to problems with the manufacturing process. For instance, an unusually high number of holes detected in a papermaking process may mean an excessively high shower pressure or low stock temperature.

Finding the root cause of such problems in the vast amount of available data from various sources in the process, however, is typically a difficult challenge. One problem with determining problematic variables is that the cause of the problem may be “run-related.” Often, different products (e.g., different types of paper) may be produced on the same manufacturing line, which requires changing machine conditions for each different type or grade of paper. Such a run-related issue may include, for example, where a dryer configuration (or draw configuration) may cause holes in one type of paper while producing a superior product for another.

In addition, certain types of false readings may complicate the data analysis process. For example, an optical system may be used to count holes in the paper, and a piece of dust on the lens of the system may produce false hole readings. The dust may have contaminated the lens during production, between two runs of two different paper types, or between two runs of the same paper type.

There thus exists a need for improved data analysis systems capable of compiling data from a plurality of different sources in a manufacturing process and capable of a multitude of data compiling, filtering, and graphical methods for comparing and analyzing the data.

### SUMMARY

This disclosure provides novel methods of analyzing data trends associated with manufacturing processes. The processes typically have one or more process variables that include a plurality of data points. In an embodiment, two or more of the datasets represent a same process variable. It should be appreciated that the described method may be used in a wide variety of manufacturing processes. For example, such processes may include any plant, production line, system, machine, or the like. Particular industries may include papermaking, petrochemical, desalination, cooling towers, and the like. Representative process variables include temperature, pressure, other signals, counts, time, codes, states of operation, such as downtime, stoppage, and uptime, chemical levels, and the like.

A feature of the invention that makes possible such wide applicability is that the invention is capable of receiving any type of data from any type of source. Typically, manufacturing processes includes a multitude of variables, each variable having or generating its own dataset. A system controller or other storage device generally archives and stores these datasets. The invention is capable of receiving data from such archived sources or may alternatively receive data in real-time or substantially real-time directly or indirectly from data capturing equipment.

In an aspect, the invention includes a method of receiving at least two datasets from a plurality of datasets associated with the manufacturing process. The received datasets form a combined dataset. In an embodiment, a plurality of the received datasets may be merged to form one or more merged datasets, and the combined dataset optionally includes one or more of the merged datasets. At least one user-selected criterion is then defined to create a process study, followed by determining a subset of the data points in the combined dataset for the process study. According to alternative embodiments, the subset may include either each and every data point in the combined dataset or only a portion of the data points in the combined dataset.

In one embodiment, a graphical format is used to compare data trends between a master dataset and one or more of the received datasets. In other embodiments, a tabular format or a combination graphical/tabular format is used. Any of the received datasets may be chosen as the master dataset. One of the received datasets is typically designated as a master dataset. The process study is performed by choosing one or more of the data points in one or more of the remaining received datasets by aligning one or more of the data points in the master dataset with corresponding data points in one or more of the chosen datasets based upon the user-selected criterion. In an embodiment, the method includes creating a transformed version of the master dataset and aligning the master dataset with the transformed version of the master dataset.

A mathematical function, such as an averaging, totalizing, minimizing, maximizing, statistical, cumulative sum, or other suitable function, is applied to the either all or a subset of the aligned data points. The resulting plurality of mathematical results is displayed in graphical, tabular, or other suitable format to analyze and compare the chosen dataset(s) and the master dataset. Alternatively, one or more of the chosen datasets may be compared with a transformed version of itself, where a mathematical/statistical function has been applied to that dataset.

In another aspect, the invention is directed to methods of analyzing time-based data trends associated with a manufacturing process having one or more process variables. The method includes receiving at least two datasets from a plurality of datasets associated with the manufacturing process to form a combined dataset. The datasets are derived from either archived manufacturing process data or real-time or substantially real-time manufacturing process data. Each dataset represents at least one of the process variables and includes a plurality of data points with a timestamp typically associated with one or more of the data points. In an embodiment, two or more of the datasets represent a same process variable. In an embodiment, a plurality of the received datasets is merged to form one or more merged datasets, and the combined dataset includes one or more of the merged datasets.

In a preferred embodiment, one of the received datasets is designated as a master dataset, which includes defining timestamps associated with one or more of the data points in the master dataset as the master time stamps for a specific time interval associated with each of those data points. One or more of the remaining received datasets is then chosen for aligning one or more of its data points with corresponding data points in the master dataset within the specific time interval. In an embodiment, a transformed version of the master dataset is created and aligning includes aligning the master dataset with the transformed version of the master dataset. A plurality of mathematical results is calculated based upon a mathematical function applied to the aligned data points and the results are displayed in a graphical, tabular, or combination format to analyze data trends over time between data points.

In a further aspect, the invention includes a computing device for analyzing a graphical or tabular display derived from executing a mathematical function on one or more datasets received from a manufacturing process. As above, the datasets include a plurality of data points and represent at least one process variable. In an embodiment, two or more of the raw datasets represent a same process variable. In an embodiment, the computing device includes a connection operable to receive at least two datasets from a plurality of datasets associated with the manufacturing process. The datasets may be derived from either archived manufacturing process data or real-time or substantially real-time manufacturing process data.

In an embodiment, the computing device includes a controller operable to perform several tasks: (i) form one or more combined datasets including the received datasets; (ii) optionally merge a plurality of the received datasets to form one or more merged datasets, wherein one or more of the combined datasets include one or more of the merged datasets; (iii) receive a user-selected criterion to create a process study; (iv) designate one of the received datasets in the combined dataset as a master dataset; (iv) align one or more of the data points in the master dataset with corresponding data points in each chosen dataset based upon the user-selected criterion; and (v) calculate a plurality of mathematical results based upon a mathematical function applied to said aligned data points.

In another embodiment, the computing device includes a user-input device to receive the user-selected criterion and optionally additional input. Preferably, the computing device further includes a display device operable to display one or more the datasets, one or more of the combined datasets, one or more of the merged datasets, and/or said mathematical results in a tabular, graphical, or combination format.

It is an advantage of the invention to provide a data analysis tool capable of receiving a plurality of datasets from a manufacturing process and allowing a user to analyze those datasets by applying a process study to the data.

It is another advantage of the invention to provide a method of visualizing data trends based on one or more received datasets from a manufacturing process.

A further advantage of the invention is to provide a method of rendering a multitude of data points from a manufacturing process to enable analyzing data trends present in the multitude of data points.

Another advantage of the invention is to provide a data analysis method including designating a master dataset selected from a plurality of datasets received from a manufacturing process and creating and applying a process study to analyze and compare trends in the data.

It is a further advantage of the invention to provide a method of receiving a plurality of datasets from a manufacturing process, filtering one or more of the datasets, designating one of those datasets as a master dataset, and comparing one or more the received datasets to the master dataset.

It is yet another advantage of the invention to provide a computing device for analyzing manufacturing process data.

Additional features and advantages are described herein, and will be apparent from, the following Detailed Description, Figures, and Examples.

### BRIEF DESCRIPTION OF THE DRAWINGS

FIG. 1 is a block diagram showing the general system architecture for a manufacturing network system with multiple components and capable of capturing, transmitting, archiving, and analyzing manufacturing process variables.

FIG. 2 is a more detailed block diagram showing general system architecture for data analysis station 112, as also shown in FIG. 1.

FIG. 3 is a flowchart of an example method 300 for analyzing data trends associated with a manufacturing process, which may be executed by data analysis station 112.

FIG. 4 is an example data structure or combined dataset holding manufacturing process data gathered from the data capture devices of FIG. 1.

FIG. 5 is an example graph of some of the “fiber retained” variable data points from FIG. 4.

FIG. 6 is a flowchart of an example method 600 for analyzing time-based data trends associated with a manufacturing process, which may be executed by data analysis station 112.

FIG. 7A illustrates a representative “thumbnail” style view of several different process variables.

FIGS. 7B to 7E show more detailed views of the thumbnails 702 to 708 of FIG. 7A.

### DETAILED DESCRIPTION

“Manufacturing Process” refers to its broadest possible interpretation. For example, such processes may include any plant, production line, system, machine, or the like. Particular industries may include papermaking, petrochemical, desalination, cooling towers, and any other industry where data collection and analysis/comparison may aid in making a manufacturing process more efficient or productive.

“Process variables” refer to any trackable variable or parameter in a manufacturing process. Representative variables include signals, counts, time, codes, states of operation, such as downtime, stoppage, and uptime, chemical levels, and the like. Variables are typically measured with any type of suitable data capturing equipment, such as motion detectors, position sensors, temperature sensors, thermocouples, pressure sensors, and/or any other suitable device.

“Connection,” “interface,” “network,” and like terms refer to any type of data transmission device including network, cable, digital subscriber line, wireless, internet, etc. Any suitable interface standard(s), such as an ethernet interface, wireless interface (e.g., IEEE 802.11a/b/g/x), bluetooth, universal serial bus, telephone network, digital subscriber line, the like, and combinations of such interfaces/connections may be used. Any of the described devices (e.g., plant archiving system, data analysis station, data capture device, process station, etc.) may be connected to one another using the above-described or other suitable interface or connection.

“Controller system,” “controller,” and similar terms refer to a manual operator or an electronic device having components such as a processor, memory device, digital storage medium, cathode ray tube, liquid crystal display, plasma display, touch screen, or other monitor, and/or other components. The controller is preferably operable for integration with one or more application-specific integrated circuits, programs, computer-executable instructions or algorithms, one or more hard-wired devices, wireless devices, and/or one or more mechanical devices. Some or all of the controller system functions may be at a central location, such as a network server, for communication over a local area network, wide area network, wireless network, internet connection, microwave link, infrared link, and the like. In addition, other components such as a signal conditioner or system monitor may be included to facilitate signal-processing algorithms.

In one embodiment, the method includes an automated controller. In another embodiment, the controller is manual or semi-manual. For example, where the manufacturing process includes one or more datasets received from a boiler system (e.g., in a petrochemical plant or papermaking operation), the controller may either automatically determine which data points/datasets to further process or an operator may partially or fully make such a determination. A dataset from a boiler system, for instance, may include variables such as oxidation-reduction potential, dissolved oxygen, levels of certain chemicals (e.g., determined empirically, automatically, fluorescently), temperature, pressure, dissolved or suspended solids, etc.

In a further embodiment, process variables may be received from archived/real-time/substantially real-time from, for example, a papermaking process. Such real-time reception may include, for example, “streaming data” over computer network. Variables may include thousands of data points derived from sources such as amount of fiber retained, fiber opacity sheet ash, jet velocity, moisture content, wire speed, press speed, dryer speed, dryer draw, pulp temperature, number of holes detected, etc. These variables and associated data points are typically analyzed in a process study formed through receiving the datasets and applying a user-selected criterion (or several criteria), as explained in more detail below. In a preferred embodiment, an operator selects the user-selected criterion based upon intimate knowledge with the particular manufacturing process in question.

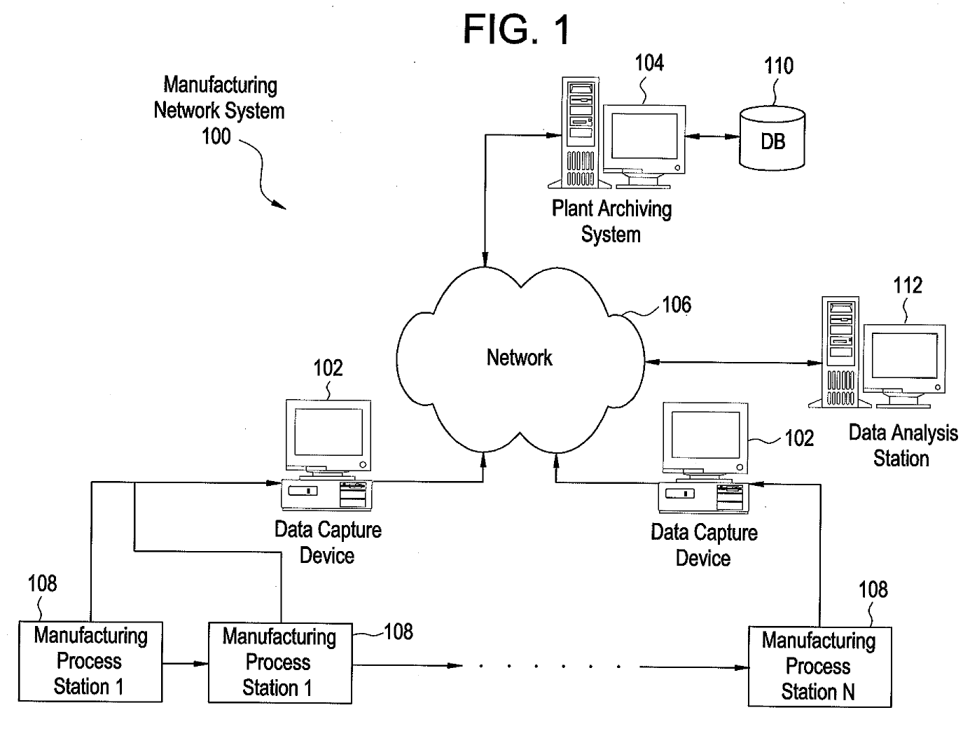

It should be appreciated that any suitable device may be used for any of the described electronic or computing devices, including plant archiving system 104, database 110, data capture device(s) 102, manufacturing process station(s) 108, and data analysis station(s) 112, as depicted in FIG. 1. These computing devices and data capturing/storing devices may include any type of personal computer and/or any other suitable computing device, including handheld, laptop, and other types of devices. Data capture device(s) 102 preferably include a main computing unit that have one or more processors electrically coupled by an address/data bus to one or more memory devices, one or more interface circuits, and one or more other circuits. The processor may be any suitable processor capable of executing the described algorithms, such as a microprocessor, a microcontroller-based platform, a suitable integrated circuit or one or more application-specific integrated circuits. The computing device may have any type of suitable memory, such as random access memory, read only memory, flash memory, and/or electrically erasable programmable read only memory. Moreover, it is also contemplated that any needed sensors, couplers, connectors, or other data measuring/transmitting equipment will be used to capture and transmit data.

In some embodiments, the computing devices of the invention may have certain minimum memory and/or processor speed requirements. In such cases, the suitable memory or computer storage device may include a permanently mounted/integrated or detachable/removable memory device. This device may also store digital data indicative of software programs, documents, files, programs, web pages, etc. retrieved from another computing device and/or loaded via an input device.

FIG. 1 is a block diagram showing an embodiment of general system architecture for manufacturing network system 100. Network system 100 includes one or more data capture devices 102 and one or more plant archiving systems 104 connected via a network 106. Network 106 may be any type of suitable local, wide area, Internet, or other suitable network, such as an ethernet, fiber optic, wireless, infrared, etc. It should be appreciated that any of the devices described herein may be directly connected to each other and/or over a network through a conventional phone line, a digital subscriber line, a T-1 line, a coaxial cable, a fiber optic cable, and/or any other suitable connection.

One or more data capture devices 102 receive data from a plurality of different manufacturing process stations 108 during a manufacturing process. For example, in a papermaking process a first data capture device 102 may send data about the amount of fiber retained, a second data capture device 102 may send data about the fiber opacity sheet ash, and additional data capture devices 102 may send data about jet velocity, moisture content, wire speed, press speed, dryer speed, dryer draw, pulp temperature, number of holes detected, etc. Such data capture devices 102 preferably send this data to the plant archiving system 104 via the network 106. The plant archiving system 104 then stores the data in a database 110.

Database 110 may be part of the plant archiving system 104 and/or connected via network 106. One or more plant archiving system(s) 104 may interact with a large number of data capture devices 102. Database 110 may be stored in any suitable format. For example, database 110 may be a SQL database and/or an Excel spreadsheet. In addition, database 110 may be stored on any type of suitable medium. For example, database 110 may be stored on a hard drive, CD drive, DVD drive, and/or other suitable storage device(s) may be used. Accordingly, each plant archiving system 104 is typically a high-end computer with a large storage capacity, one or more fast microprocessors, and one or more high-speed network connections. Conversely, relative to a typical plant archiving system 104, each data capture device 102 usually includes less storage capacity and computing power.

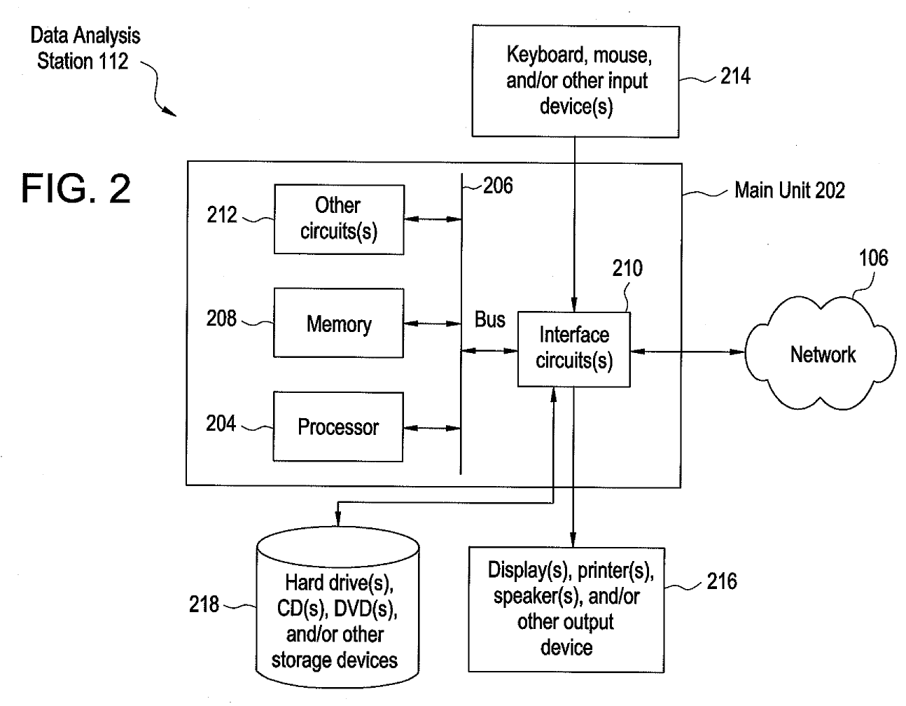

FIG. 2 is a more detailed block diagram showing general system architecture for data analysis station 112. A described above, data analysis station 112 may include a personal computer and/or any other suitable computing device. Data analysis station 112 preferably also includes a main unit 202 which preferably includes one or more processors 204, electrically coupled by an address/data bus 206 to one or more memory devices 208, one or more interface circuits 210, and one or more other circuits 212. Though any suitable memory may be used, memory device(s) 208 preferably include volatile memory and/or non-volatile memory. Preferably, memory 208 (in conjunction with storage device(s) 218) stores a software program that interacts with the other devices in the system 100 as described below. Processor 204 executes this software program in any suitable manner. However, some of the steps described below in connection with the methods may be performed manually and/or without the use of the data analysis station 112. In one embodiment, part or all of the program code can be stored in a detachable or removable memory device, including, but not limited to, a suitable cartridge, disk or CD ROM.

In a preferred embodiment, one or more input devices 214 may be connected to the interface circuit 210 for entering data and commands into the main unit 202. For example, input device 214 may be a keyboard, mouse, touch screen, track pad, track ball, isopoint, and/or a voice recognition system. In an embodiment one or more displays, printers, speakers, and/or other output devices 216 may also be connected to the main unit 202 via the interface circuit 212. Display 216 may be a cathode ray tube (CRTs), liquid crystal displays (LCDs), touch-screen, or any other type of suitable display. Display 216 generates visual displays of data generated during operation of data analysis station 112. For example, the display 216 may be used to display web pages received from the plant archiving system 104 and graphs/tables that data analysis station 112 generates through the described algorithm. The visual displays may also include prompts for human input, run time statistics, calculated values, data, etc.

The focus of this disclosure is the inner workings, such as algorithms and encoded computer-readable instructions encompassed in data analysis station 112. Data analysis station 112 may be the same device as the plant archiving system 104, or the data analysis station 112 may be a separate device. In one embodiment, data analysis station 112 receives data from the system, such as from one or more data capture devices 102, in real-time or substantially real-time without the need for access to plant archiving system 104. In an embodiment, data capture devices 102 send data to both data analysis station 112 and plant archiving system 104. In another embodiment, once the manufacturing process data is stored in the plant archiving system database 110, one or more data analysis stations 112 may retrieve the data via the network 106. For example, an authorized person may request certain manufacturing data via any one of the described or other network designs.

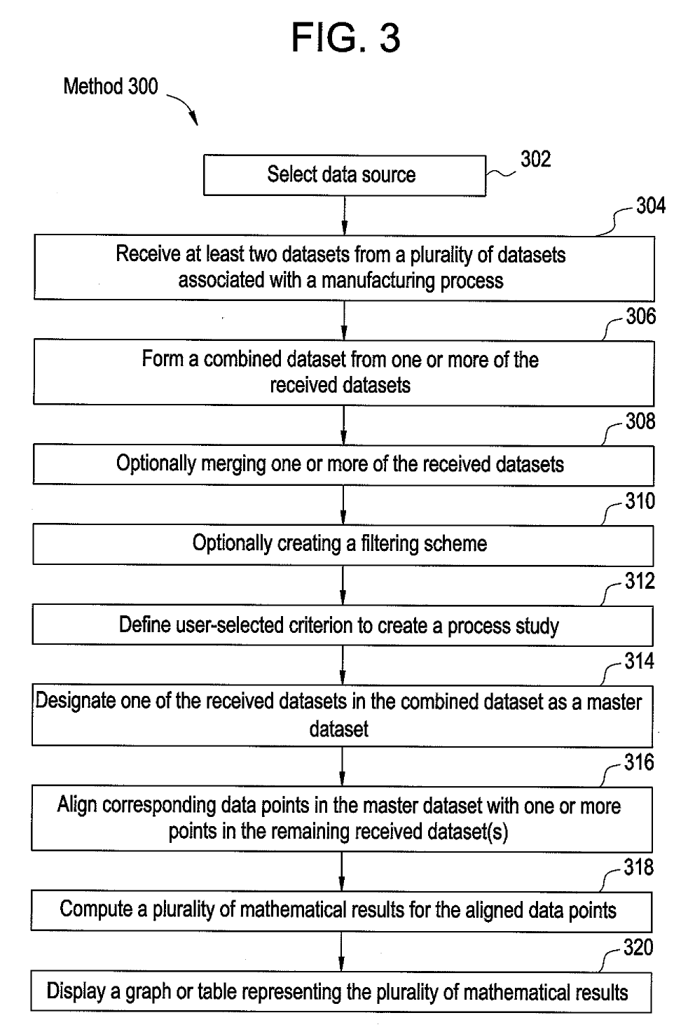

A flowchart of an example method 300 for analyzing data trends associated with a manufacturing process is illustrated in FIG. 3. Preferably, method 300 is embodied in one or more software programs, which is stored in one or more memories and executed by one or more processors. Block 302 represents possible sources of datasets for receiving data associated with a manufacturing process to implement the described method. In alternative embodiments, data may be received include real-time, substantially real-time, or through a connection to plant archiving system 104.

It should be appreciated that the data source is a broad concept and the data may be derived from various manufacturing stations 108 or the like. For example, a papermaking process may produce thousands of data points about the amount of fiber retained, fiber opacity sheet ash, jet velocity, moisture content, wire speed, press speed, dryer speed, dryer draw, pulp temperature, number of holes detected, etc. The data capture devices 102 may by built in to one or more manufacturing stations 108, and/or the data capture devices 102 may be separate devices from the manufacturing stations 108. Preferably, the data capture devices 102 capture digital data and/or convert analog sensor reading into digital data. For example, a data capture device 102 may use an analog-to-digital converter to take a periodic temperature reading, or a data capture device 102 may us a charge-coupled device to look for holes. Similarly, a plurality of plant archiving systems 104 may exist for a given process or a multitude of processes.

In block 304, at least two datasets from a plurality of datasets are received from a plurality of datasets associated with a manufacturing process to form a combined dataset, as shown in block 306. In an embodiment, each dataset represents at least one process variable and includes a plurality of data points. Alternatively, two or more of the datasets may represent a same process variable. In one embodiment, method 300 includes merging a plurality of the received datasets (block 308) to form one or more merged datasets, where the combined dataset of block 306 includes one or more of the merged datasets.

In an embodiment, method 300 includes creating a filtering scheme. For example, filtering may entail excluding data points in one or more of the received datasets outside of a given range (e.g., higher or lower value than a user-defined value) and executing all or part of method 300 on the filtered data points. In an embodiment, the filtering scheme may include determining if any data points have a null or non-numerical value and assigning either a same or a different numerical value to or deleting one or more of those data points. In an embodiment, a copy of a filtering scheme is created and stored for later use.

The filtering scheme may also include, for example, where one or more data points appear to be erroneous to the user, and the user removes the erroneous data points while performing any mathematical/statistical analysis on the data. Accordingly, the user may enter one or more threshold values for one or more variables, to filter the data points within or outside of the threshold values. The variable may be selected by clicking on a displayed graph and/or the variable name in a list of process variables. The threshold values may be, for instance, minimums, maximums, and/or ranges. The data analysis station 112 then filters the retrieved subset of data based on the threshold value(s) entered by the user. As a more specific example, a CCD system may be used to count holes in the paper, and a large piece of dust on a lens may produce false hole readings. If a typical number for the maximum number of holes equals ten, and a plurality of hole readings is indicating fifty-plus holes, the user may want to filter out hole counts above twenty-five to remove the erroneous data.

Block 312 depicts defining at least one user-selected criterion to create a “process study.” The data analysis station 112 creates a process study, which contains a collection of the data analysis type, all filtering and erroneous data removal criteria, cursor criteria, and graphing options. For example, such filtering may include adjusting, minimizing, averaging, etc. values for a certain process variable that were erroneously measured/archived. Filtering may include substituting values for erroneous data or deleting certain strings of data for one or more of the process variables.

This selection allows the user to create a multitude of process studies with similar, but slightly different criteria without having to re-initiate each individual criterion for each study. Typically, two data analysis types are used: (i) a cause/effect analysis, in which a user-specified dependent variable is analyzed to determine which independent variables have the greatest impact on that dependent variable and (ii) a trial analysis, in which subsets of the master dataset are determined by user-specified break-points through the selection of timestamps or other indicators in the data set. The subsets are then graphically or tabularly represented and compared to each other, as described in more detail below.

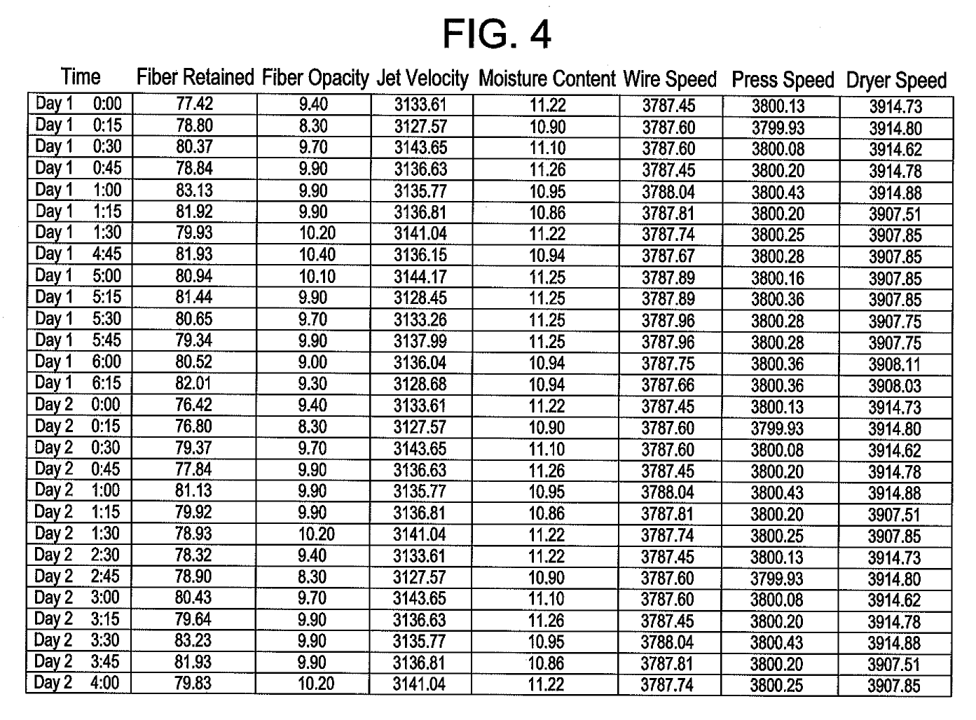

In response to the user selection, the data analysis station 112 analyzes the subset of data that is associated with the user selection, where the subset may include each and every data point or only a portion of the data points in one or more of the received datasets or the combined dataset. For example, data analysis station 112 may analyze the “fiber retained” data for a specific time interval within the data set. An example of a received and filtered data structure holding manufacturing process data in a combined dataset is shown in FIG. 4. In an embodiment, the user selects to align one or more data points in the master dataset with corresponding data points in one or more of the remaining received datasets based upon the user-selected criterion, as shown in block 316.

To display the compared data in a graphical or tabular format, a mathematical function may be applied to the either all or a subset of the aligned data points (block 318). According to alternative embodiments, the mathematical function may include any well-known or user-created statistical function, such as a minimizing, maximizing, totalizing, or averaging function, and may also include other functions, such as a cumulative sum or other function.

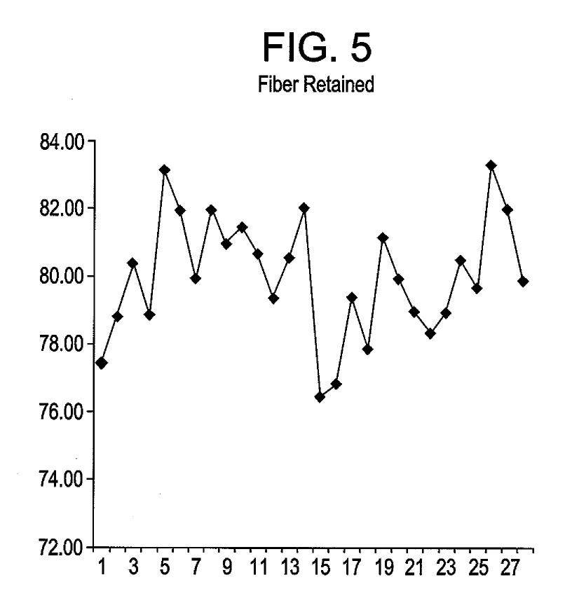

The data analysis station 112 may then display a graph or table of the selected data according to an embodiment, as shown in block 320. It is also contemplated that graphs or tables may be displayed at any point in the method to aid in the process study or in applying the mathematical function. An example graph of the “fiber retained” variable from the combined dataset of FIG. 4 is shown in FIG. 5.

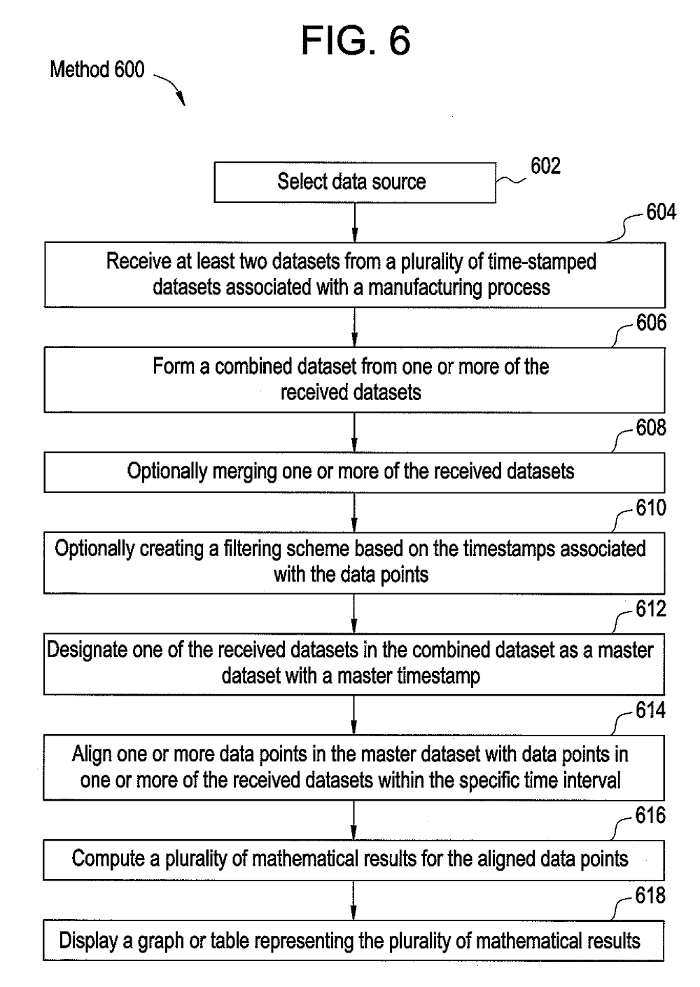

FIG. 6 is a flowchart of an example method 600 for analyzing time-based data trends associated with a manufacturing process, which may be executed by data analysis station 112. Preferably, method 600 is embodied in one or more software programs, which is stored in one or more memories and executed by one or more processors. Block 602 represents possible sources of datasets for receiving data associated with a manufacturing process to implement the described method. In alternative embodiments, data may be received include real-time, substantially real-time, or through a connection to plant archiving system 104. The broad description for data source provided above for method 300 equally applies for method 600.

In block 604, at least two datasets from a plurality of datasets are received to form a combined dataset, as shown in block 606. In an embodiment, each dataset represents at least one process variable and includes a plurality of data points, and each data point includes an associated timestamp that represents the exact (or near exact) relative time (or specific date/time) the data point was measured/archived. In some embodiments, the timestamps may represent a random sampling rate or more regularly spaced time intervals. Specific sampling rates and time points may vary considerably depending on the particular manufacturing process and will be apparent to those skilled in the art.

In one embodiment, method 600 includes merging a plurality of the received datasets (block 608) to form one or more merged datasets, where the combined dataset of block 606 includes one or more of the merged datasets.

In an embodiment, method 600 includes creating a filtering scheme as shown in block 610, which operates as described for method 300 above. In addition, the filtering scheme may include determining whether one of the data points within one or more of the received datasets include a same or similar value with a different associated timestamp, and optionally averaging, totalizing, minimizing, or maximizing those data points having the same or similar value. As shown in block 612, method 600 includes designating one of the received datasets as a master dataset. The timestamps associated with one or more of the data points in the master dataset are then defined as master timestamps for a specific time interval, which may be as long or short as needed. Though only a portion of the data points in the master dataset may have associated master time stamps, preferably, all of the data points in the master dataset, either before or after filtering, are designated as having an associated master timestamp.

As part of method 600, data points in the master dataset are aligned with data points in one or more of the other datasets in a timestamp-based fashion, as shown in block 614. To display the compared data in a graphical or tabular format, a mathematical function may be applied to the either all or a subset of the aligned data points (block 616). According to alternative embodiments, the mathematical function may include any well-known or user-created statistical function, such as a minimizing, maximizing, totalizing, or averaging function, and may also include other functions, such as a cumulative sum or other function.

The data analysis station 112 may then display a graph or table of the selected data according to an embodiment as shown in block 618. It is also contemplated that graphs or tables may be displayed at any point in the method to aid in aligning the described timestamps or in applying the mathematical function.

Although processes 300 and 600 include references to the flowcharts illustrated in FIGS. 3 and 6, it should be appreciated that many other methods of performing the acts associated with these processes may be used. For example, the order of many of the blocks may be changed, many of the blocks described may be optional, and other additional steps may be incorporated into the method.

Generally, the method 600 enables a user to select variables and mathematical functions from a plurality of manufacturing process variables existing on a plurality of plant archiving systems and a plurality of mathematical functions. The method then automatically detects the data collection sample rate and merges a plurality of data sets into one dataset with one time stamp for each data point. In addition, the method may engage a filtering scheme for certain variables that do not sit above or fall below a certain threshold and/or within a certain range.

### EXAMPLES

The foregoing may be better understood by reference to the following examples, which are intended for illustrative purposes and are not intended to limit the scope of the invention.

### Example 1

In this Example, various Head Box datasets were received from a papermaking process. The dataset in Table 1 was selected as the master dataset, where its master timestamp was in one-hour increments. The dataset shown in Table 2 was to be combined or merged with the master dataset of Table 1 and includes a timestamp in fractional hour increments (displayed in hours:minutes). Data points in Table 2 having the closest timestamp to corresponding master timestamps in Table 1 were aligned to create a combined/merged dataset. Table 3 shows the combined dataset with the data points aligned to the master timestamp of the data points in Table 1.

TABLE 1

| Time Stamp | Total Charge |
|---|---|
| 0 | −377 |
| 1 | −371 |
| 2 | −447 |
| 3 | −439 |
| 4 | −437 |
| 5 | −346 |
| 6 | −363 |
| 7 | −207 |
| 8 | −222 |
| 9 | −352 |
| 10 | −376 |
| 11 | −388 |
| 12 | −412 |
| 13 | −429 |
| 14 | −337 |
| 15 | −306 |

TABLE 2

| Time Stamp | Ash Shift | Consistency Shift | Freeness Shift |
|---|---|---|---|
| 0:58 | 11.4 | 0.53 | 80 |
| 2:54 | 11.85 | 0.54 | 90 |
| 4:50 | 11.73 | 0.53 | 95 |
| 6:46 | 10.45 | 0.53 | 92 |
| 8:42 | 11.72 | 0.54 | 95 |
| 10:38 | 10.31 | 0.52 | 92 |
| 12:34 | 8.82 | 0.51 | 97 |
| 14:30 | 7.52 | 0.53 | 102 |

TABLE 3

| Time | Total | Ash | Consistency | Freeness |
|---|---|---|---|---|
| Stamp | Charge | Shift | Shift | Shift |
| 0 | −377 | — | — | — |
| 1 | −371 | 11.4 | 0.53 | 80 |
| 2 | −447 | — | — | — |
| 3 | −439 | 11.85 | 0.54 | 90 |
| 4 | −437 | — | — | — |
| 5 | −346 | 11.73 | 0.53 | 95 |
| 6 | −363 | — | — | — |
| 7 | −207 | 10.45 | 0.53 | 92 |
| 8 | −222 | — | — | — |
| 9 | −352 | 11.72 | 0.54 | 95 |
| 10 | −376 | — | — | — |
| 11 | −388 | 10.31 | 0.52 | 92 |
| 12 | −412 | — | — | — |
| 13 | −429 | 8.82 | 0.51 | 97 |
| 14 | −337 | 7.52 | 0.53 | 102 |
| 15 | −306 | — | — | — |

### Example 2

Setting one or more thresholds is a method of filtering erroneous readings. For example, an optical system may be used to count holes in the paper, and a large piece of dust on a lens may produce false hole readings. If a typical number for the maximum number of holes equals ten, and a plurality of hole readings is indicating fifty plus holes, the user may want to filter out hole counts above twenty-five to remove the erroneous data. An example of such filtered data is shown in Tables 4 (unfiltered) and 5 (filtered). Time are shown in hour:minute format.

TABLE 4

| Time Stamp | Hole Count |
|---|---|
| Day 1 - 0:58 | 7 |
| 2:54 | 1 |
| 4:50 | 5 |
| 6:46 | 9 |
| 8:42 | 6 |
| 10:38 | 3 |
| 12:34 | 50 |
| 14:30 | 50 |
| 16:26 | 50 |
| 17:24 | 50 |
| 18:22 | 3 |
| 19:20 | 3 |
| 20:18 | 5 |
| 21:16 | 9 |
| 22:14 | 9 |
| 23:12 | 10 |
| Day 2 - 0:10 | 9 |
| 1:08 | 8 |
| 2:06 | 4 |
| 3:04 | 6 |
| 4:02 | 2 |
| 5:00 | 1 |

TABLE 5

| Time Stamp | Hole Count |
|---|---|
| Day 1 - 0:58 | 5 |
| 2:54 | 2 |
| 4:50 | 5 |
| 6:46 | 7 |
| 8:42 | 7 |
| 10:38 | 2 |
| 12:34 | — |
| 14:30 | — |
| 16:26 | — |
| 17:24 | — |
| 18:22 | 5 |
| 19:20 | 4 |
| 20:18 | 4 |
| 21:16 | 9 |
| 22:14 | 4 |
| 23:12 | 8 |
| Day 2 - 0:10 | 2 |
| 1:08 | 3 |
| 2:06 | 6 |
| 3:04 | 5 |
| 4:02 | 6 |
| 5:00 | 3 |

### Example 4

After a plurality of data points are captured for a plurality of different variables, the method will determine the primary data collection rate and merge the plurality of data sets with different time stamps for each data point into one data set with one time stamp for each data point. Before the merge can be accomplished, however, all non-numerical data in each data set is identified and presented in table format to the user. The user then assigns a numerical or null value to the non-numerical data. The merge can then take place. Table 7 illustrates a dataset having such non-numerical data and Table 8 shows a reassignment schedule to filter such data points and replace them with null or numerical data.

TABLE 7

| Time | | Consistency | Freeness |
|---|---|---|---|
| Stamp | Hole Count | Shift | Shift |
| Day 1 - 0:58 | 9 | 0.53 | 80 |
| 2:54 | System Down | 0.54 | 90 |
| 4:50 | 9 | 0.53 | 95 |
| 6:46 | 8 | 0.53 | 92 |
| 8:42 | 1 | Bad Input | 95 |
| 10:38 | 1 | 0.52 | System Down |
| 12:34 | 6 | 0.51 | 97 |
| 14:30 | 4 | 0.53 | 102 |
| 16:26 | 8 | 0.53 | 92 |
| 17:24 | 9 | Not Found | 45 |
| 18:22 | 10 | 0.49 | 87 |
| 19:20 | Error 103 | 0.27 | 67 |
| 20:18 | 5 | 0.53 | 100 |
| 21:16 | 4 | 0.18 | 89 |
| 22:14 | 3 | 0.54 | 111 |
| 23:12 | 5 | 0.57 | 102 |
| Day 2 - 0:10 | 8 | 0.56 | 90 |
| 1:08 | 4 | Getting Low | 87 |
| 2:06 | 3 | 0.54 | 96 |
| 3:04 | Down | 0.62 | 98 |
| 4:02 | 4 | 0.56 | 88 |

TABLE 8

| Variable Name | Current Value | New Value |
|---|---|---|
| Hole Count | System Down | — |
| Consistency Shift | Bad Input | 0 |
| Freeness Shift | System Down | — |
| Consistency Shift | Not Found | — |
| Hole Count | Error 103 | — |
| Consistency Shift | Getting Low | 0 |
| Hole Count | Down | — |

### Example 5

The time stamp for each data set may be aligned to the nearest time stamp (i.e., within a specific time interval) of the master data set. If the intermediate data set contains multiple time stamps with the same value, the data for each variable with the same time stamp is averaged, totalized, minimized, or maximized (depending on the user-selected option) to one value with one time stamp. For example, if the user has selected the “average” option for a variable and one of the data sets contains three time stamps of for a certain day at 10:00 a.m., the three data points (one for each time stamp) of the variable will be averaged to one data point with a time stamp of that certain day at 10:00 a.m. Table 9 shows an exemplary dataset with 3 data points in a specific time interval around 10:00 a.m. (i.e., the same time stamp). Table 10 shows the aligned data points where the method “averaged” the values within that specific time interval. The timestamps are in hour:minute format.

TABLE 9

| | | Head Box | Head Box |
|---|---|---|---|
| Time Stamp | Hole Count | Consistency | Freeness |
| 0:10 | 9 | 0.56 | 90 |
| 1:08 | 9 | 0.67 | 87 |
| 2:06 | 1 | 0.54 | 96 |
| 3:04 | 3 | 0.62 | 98 |
| 4:02 | 10 | 0.56 | 88 |
| 5:00 | 4 | — | — |
| 5:58 | 7 | 0.51 | 84 |
| 6:56 | 8 | — | — |
| 7:54 | 9 | 0.56 | 98 |
| 9:42 | 2 | 0.6 | 102 |
| 9:50 | 9 | 0.6 | 107 |
| 10:18 | 9 | 0.55 | 111 |
| 11:46 | 3 | 0.52 | 109 |

TABLE 10

| | | Head Box | Head Box |
|---|---|---|---|
| Time Stamp | Hole Count | Consistency | Freeness |
| 0:00 | 9 | 0.56 | 90 |
| 1:00 | 9 | 0.67 | 87 |
| 2:00 | 1 | 0.54 | 96 |
| 3:00 | 3 | 0.62 | 98 |
| 4:00 | 10 | 0.56 | 88 |
| 5:00 | 4 | — | — |
| 6:00 | 7 | 0.51 | 84 |
| 7:00 | 8 | — | — |
| 8:00 | 9 | 0.56 | 98 |
| 10:00 | 6.667 | 0.583 | 106.667 |
| 12:00 | 3 | 0.52 | 109 |

### Example 6

Once the merge has been accomplished, the data analysis station 112 displays a data grid containing all of the variables in the data set, the time stamp, and all of the data for each variable aligned to the master time stamp. The generated graphs may be viewed through a graphical overview of the variables or from a list of the available process variables. The user does not have to manually search for an individual graph of the data.

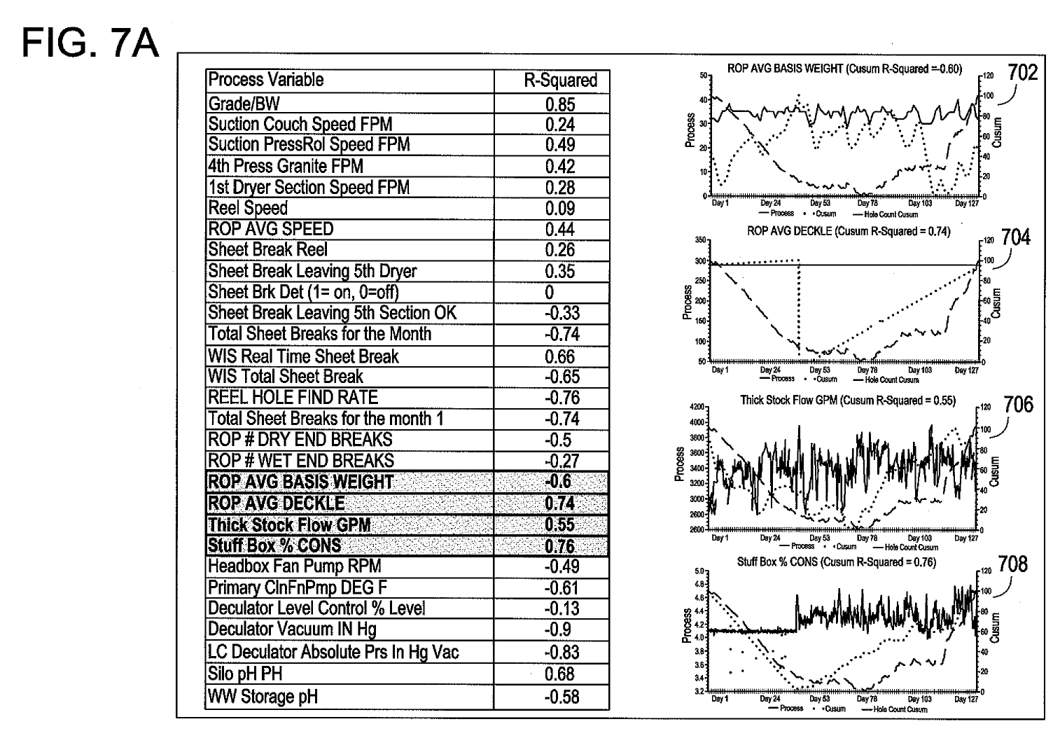

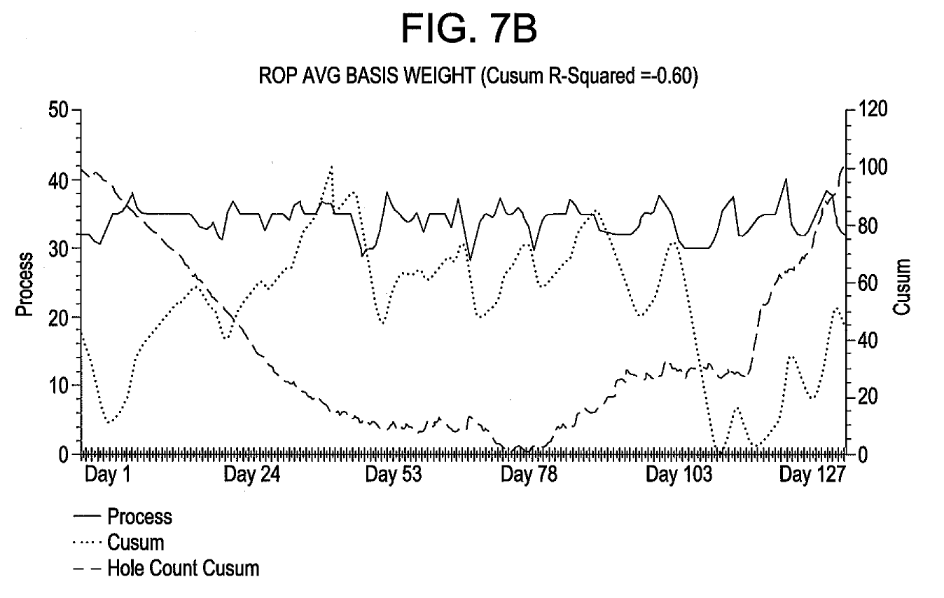

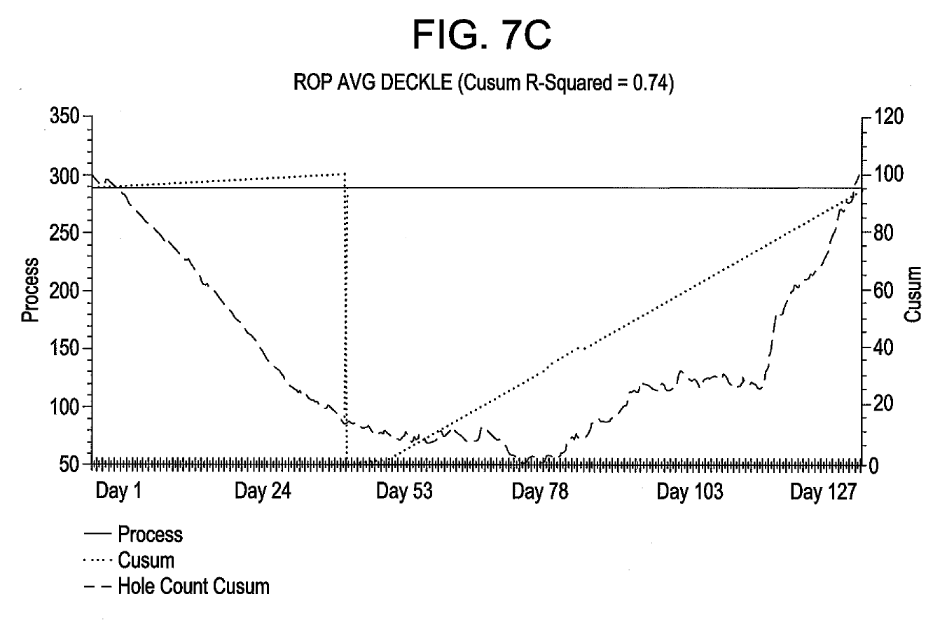

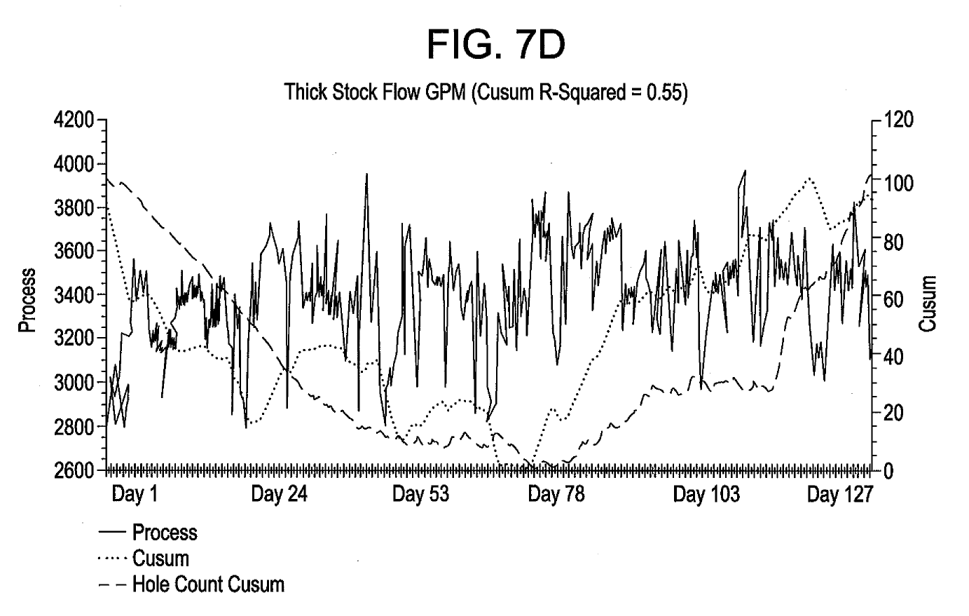

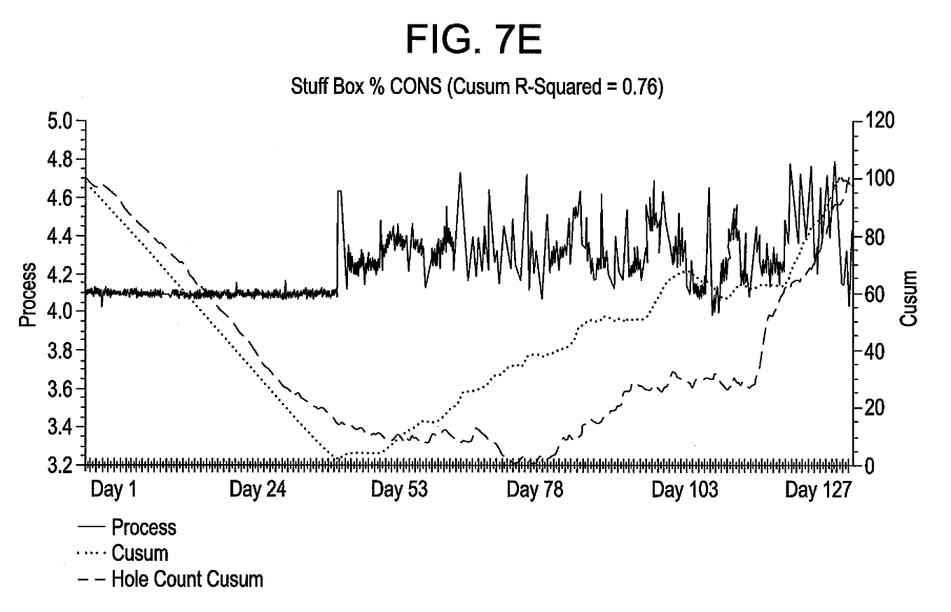

FIG. 7a displays an exemplary view of several different variable analyses. The table to the left of the four graphs lists some of the variables available for analysis. The four graphs in FIGS. 7b to 7e (corresponding to labels 702 to 708 in FIG. 7a, respectively) each include a graphical display of data points for the indicated variable, the cumulative sum of that data, and a comparison (i.e., master dataset) to the cumulative sum for hole count. FIG. 7a depicts an example of a “thumbnail” display for the several variables. One or more the thumbnails may be user-selected for detailed display, as in FIGS. 7b to 7e.

### Example 7

The data analysis station 112 may also display a list of mathematical/statistical functions. For example, the data analysis station 112 may display a drop down box with choices such as max, min, average, frequency, correlation, standard deviation, cumulative sum, etc. The data analysis station 112 then receives one or more statistical functions selections from the user to be applied to all or a selected portion of the data points. For example, the user may want to see the average data value for the selected variable(s).

Once at least one manufacturing process variable is selected, at least one mathematical function is selected, which the data analysis station 112 executes to produce at least one numerical result. For example, the data analysis station 112 may calculate the “average fiber retained” by a particular production run. The data analysis station 112 may then display a graph of the produced numerical results.

Methods and apparatus for analyzing data associated with a manufacturing process have been disclosed. The foregoing description has been presented for the purposes of illustration and description and various changes and modifications to will be apparent to those skilled in the art. The description is not intended to be exhaustive or to limit the invention to the exemplary embodiments disclosed. Such changes and modifications can be made without departing from the spirit and scope of the invention and without diminishing its intended advantages. It is therefore intended that such changes and modifications be covered by the appended claims.

The claimed invention is:

1. A method of analyzing data trends associated with a manufacturing process having one or more process variables, the method comprising:
(a) receiving at least two datasets from a plurality of datasets associated with the manufacturing process to form a combined dataset, the datasets derived from either archived manufacturing process data or real-time or substantially real-time manufacturing process data, wherein each dataset represents at least one of the process variables and includes a plurality data points, and two or more of the datasets optionally representing a same process variable;
(b) optionally merging a plurality of the received datasets to form one or more merged datasets, wherein the combined dataset includes one or more of the merged datasets;
(c) defining at least one user-selected criterion to create a process study;
(d) determining a subset of the data points in the combined dataset for the process study, wherein said subset includes either each and every data point in the combined dataset or a portion of the data points in the combined dataset;
(e) designating one of the received datasets in the combined dataset as a master dataset;
(f) choosing one or more of the remaining received datasets in the combined dataset on which to perform the process study;
(g) aligning one or more of the data points in the master dataset with corresponding data points in one or more of the chosen datasets or corresponding data points in a transformed version of the master dataset based upon the user-selected criterion;
(h) calculating a plurality of mathematical results based upon a mathematical function applied to either all or a subset of said aligned data points; and
(i) displaying said mathematical results in a graphical or tabular format to analyze data trends between the aligned data points.

2. The method of claim 1, including sorting the received datasets into a plurality of combined datasets and operating steps (b) to (i) on more than one of said sorted datasets either sequentially or simultaneously.

3. The method of claim 1, including tabulating members selected from the group consisting of: the received datasets, the combined dataset, the master dataset, the remaining received datasets, the aligned data points, and any combinations thereof.

4. The method of claim 1, including operating at least a portion of the method in real-time or substantially real-time.

5. The method of claim 1, including operating at least a portion of the method over a network.

6. The method of claim 1, wherein the mathematical function is selected from the group consisting of: a statistical function and a cumulative sum.

7. The method of claim 1, wherein the graphical format is selected from the group consisting of: two-dimensional and based on a two-axis system; three-dimensional and based on a three-axis system; and combinations thereof; wherein said axes are orthogonal to one another.

8. The method of claim 1, including defining a filtering scheme and optionally creating a copy of the filtering scheme.

9. The method of claim 1, including filtering the combined dataset to exclude data points having a value higher or lower than a user-defined value and displaying the graph without said excluded data points.

10. The method of claim 1, including filtering one or more of the received datasets or the combined dataset to determine if any of data points have a null or non-numerical value and assigning either a same or a different numerical value to or deleting one or more of those data points.

11. The method of claim 1, including providing a plurality of different mathematical functions and either automatically or manually selecting at least one of the mathematical functions.

12. The method of claim 1, including displaying a graph element associated with either less than all or each and every data point or manufacturing process variable in the dataset.

13. The method of claim 1, wherein the process study is selected from the group consisting of: a cause effect analysis, a trial analysis, and combinations thereof.

14. The method of claim 1, including executing one or more of steps (a) to (i) via one or more computer-readable media encoded with computer-readable instructions operable to execute one or more of said steps.

15. A method of analyzing time-based data trends associated with a manufacturing process having one or more process variables, the method comprising:
(a) receiving at least two datasets from a plurality of datasets associated with the manufacturing process to form a combined dataset, the datasets derived from either archived manufacturing process data or real-time or substantially real-time manufacturing process data, each dataset representing at least one of the process variables and including a plurality of data points, one or more of the data points having an associated timestamp, and two or more of the datasets optionally representing a same process variable;
(b) optionally merging a plurality of the received datasets to form one or more merged datasets, wherein the combined dataset includes one or more of the merged datasets;
(c) designating one of the received datasets as a master dataset;
(d) defining the associated timestamps of one or more of the data points in the master dataset as the master time stamps for a specific time interval associated with each of those data points;
(e) choosing one or more of the remaining received datasets;
(f) aligning one or more of the data points in the master dataset with the data point(s) in one or more of the chosen datasets or with a transformed version of the data points in the master dataset within the specific time interval;
(g) calculating a plurality of mathematical results based upon a mathematical function applied to said aligned data points; and
(h) displaying said mathematical results in a graphical format to analyze data trends over time between data points

16. The method of claim 15, including filtering one or more of the received datasets to determine if more than one of the data points within one or more of the received datasets include a same or similar value with a different associated timestamp, and optionally averaging, totalizing, minimizing, or maximizing those data points having the same or similar value.

17. A computing device for analyzing a graphical display derived from executing a mathematical function on one or more datasets received from a manufacturing process, wherein one or more of the datasets include a plurality of data points, the device comprising:
(a) a connection operable to receive at least two datasets from a plurality of datasets associated with the manufacturing process, the datasets derived from either archived manufacturing process data or real-time or substantially real-time manufacturing process data, wherein each raw dataset represents at least one process variable and includes a plurality of data points, and two or more of the raw datasets optionally represent a same process variable;
(b) a controller operable to: (i) form one or more combined datasets including the received datasets; (ii) optionally merge a plurality of the received datasets to form one or more merged datasets, wherein one or more of the combined datasets include one or more of the merged datasets; (iii) receive at least one user-selected criterion to create a process study; (iv) designate one of the received datasets in the combined dataset as a master dataset; (iv) align one or more of the data points in the master dataset with corresponding data points in each chosen dataset based upon the user-selected criterion; and (v) calculate a plurality of mathematical results based upon a mathematical function applied to said aligned data points;
(c) a user-input device to receive the user-selected criterion and optionally additional input; and
(d) a display device operable to display one or more the datasets, one or more of the combined datasets, one or more of the merged datasets, and/or said mathematical results in a tabular and/or graphical format.

18. The computing device of claim 17, wherein the user-selected criterion is a time-based criterion.

19. The computing device of claim 17, including a network connection operable to relay information derived from any of steps (a) to (d).
